(19) United States
(12) Patent Application Publication
(10) Pub. No.: US 2026/0335869 A1
(43) Pub. Date: Oct. 29, 2026

(54) REFORMING CATALYST

(71) Applicant: Aether Fuels Pte. Ltd., Singapore (SG)

(72) Inventor: Shuguang Zhang, Des Plaines, IL (US)

(73) Assignee: Aether Fuels Pte. Ltd., Singapore (SG)

(21) Appl. No.: 19/381,427

(22) Filed: Nov. 6, 2025

Related U.S. Application Data
(60) Provisional application No. 63/733,021, filed on Dec. 12, 2024.

(51) Int. Cl. B01J 23/63; B01J 21/04; B01J 21/06; B01J 35/30; B01J 35/37; B01J 35/61; B01J 37/02; B01J 37/08; C01B 32/40

(52) U.S. Cl. CPC B01J 23/63; B01J 21/04; B01J 21/066; B01J 35/37; B01J 35/394; B01J 35/613; B01J 35/615; B01J 37/0201; B01J 37/0236; B01J 37/088; C01B 32/40

(57) ABSTRACT

Catalyst systems for making syngas are described herein. The catalyst systems use a solid porous support body at least partially permeated by a ceria coating with noble metal permeating the porous ceria modified support body. The catalyst systems can be used in gas phase reactions to convert methane and/or carbon dioxide into hydrogen and carbon monoxide at molar ratios favorable for use in Fischer-Tropsch chemical manufacturing processes. The catalyst systems described herein exhibit simultaneous conversion of methane and carbon dioxide in a single reaction system.

### CROSS-REFERENCE TO RELATED APPLICATIONS

This application for patent claims priority benefit of U.S. Provisional Patent Application Ser. No. 63/733,021, filed Dec. 12, 2024, which is entirely incorporated herein by reference.

### BACKGROUND

Processes to make synthesis gas (“syngas”) are becoming more popular as the need for renewable materials manufacturing grows. Catalysts are typically used to make syngas from materials such as methane and carbon dioxide. Catalyst deactivation has been a serious issue in synthesis gas formation processes, such as methane steam reforming (MSR), methane and carbon dioxide dry reforming (MDR), and reverse water gas shift (RWGS). Methane and carbon dioxide are relatively stable compounds, so chemical reactions involving methane and carbon dioxide typically involve high activation energy. High temperature is also thermodynamically favored for high conversion. In MSR, a large amount of steam is usually added to achieve high steam to carbon ratio in order to minimize coke and soot formation. Coke formation and metal sintering occur under severe reaction conditions and are considered to be the typical causes of catalyst deactivation in these reactions.

Noble metals are used as catalysts in many conventional syngas processes. Noble metals such as platinum, ruthenium, and rhodium have higher catalytic activity in MSR reactions than metals such as nickel. Among all metals conventionally used (nickel, ruthenium, rhodium, palladium, iridium, and platinum), ruthenium is known to have generally the highest activity in methane reforming reactions, MSR, MDR, and RWGS, and lowest carbon formation.

It is also known that the structure and composition of catalyst supports used for such reactions have significant effect on the performance of the catalyst. Support materials such as alumina, titania, and zirconia have been used. Ceria has been noted as a promising support for catalysts in methane reforming reactions because of unique oxygen transport activity, but ceria has lower surface area than other oxide supports, ceria loses surface area faster at high temperatures, and ceria is a very fragile material, tending to fragment into powder when subjected to even moderate flow conditions. There is need for a stable supported catalyst system with high activity for syngas manufacturing processes.

### SUMMARY

Embodiments described herein provide syngas manufacturing catalyst system having a support comprising a solid porous support body at least partially permeated by a ceria coating; and ruthenium permeating the porous ceria modified support body.

Other embodiments described herein provide methods of making a catalyst system that include immersing a porous support body in a solution comprising a ruthenium salt and a cerium salt for a permeation period; drying the porous support body; and thermally treating the dried porous body.

Other embodiments described herein provide methods of making syngas that include exposing a gas comprising methane, carbon dioxide, or both, and a hydrogen source, an oxygen source, or both, to a catalyst system at a reforming temperature, wherein the catalyst system comprises: a metal oxide support comprising a solid porous support body at least partially permeated by a ceria coating; and a ruthenium catalyst permeating the porous ceria modified support body.

### BRIEF DESCRIPTION OF THE FIGURES

FIG. 1 is a graph showing conversion of methane for two different catalyst systems, one an embodiment of the catalysts described herein, and one a comparative catalyst, as a function of continuous processing time.

FIG. 2 is a graph showing conversion of carbon dioxide in the same reactions referenced in FIG. 1.

FIG. 3 is a graph showing methane conversion for the catalysts of FIG. 1, but under different reaction conditions.

FIG. 4 is a graph showing carbon dioxide conversion for the catalyst of FIG. 1, but under the reaction conditions of FIG. 3.

FIG. 5 is a graph showing methane conversion for two platinum-based comparative catalysts.

FIG. 6 is a graph showing carbon dioxide conversion for the two platinum-based catalysts of FIG. 5.

FIG. 7 is a graph showing methane and carbon dioxide conversions for an embodiment of the catalysts described herein.

### DETAILED DESCRIPTION

The inventors have created a new catalyst system for use in making syngas for manufacturing organic chemicals. The catalyst system is usable in methane steam reforming (“MSR”), methane and carbon dioxide dry reforming (“MDR”), and reverse water gas shift (“RWGS”) reactions. The catalyst system uses a noble metal catalyst deposited on a porous support body. The porous support body, which may be any suitable metal or metalloid compound, such as oxide or carbide, is at least partially permeated by a coating of ceria. The porous support body is a structurally strong material and has a high surface area and a high pore volume, both of which favor high dispersion of ceria and the noble metal. Alumina is an example of a material that can be used. Other materials, such as titania, zirconia, silica, and silicon carbide can also be used. Combinations of such materials can be used. The ceria coating covers at least a portion of the surface of the porous support body accessible to fluids, at the exterior thereof and within pores and internal passages thereof. The noble metal also at least partially permeates the porous support body in the same way. It is believed that the noble metal is co-dispersed with the ceria along the surfaces of the support body. In some cases, the ceria is mostly between the noble metal and the porous support body. In some cases, however, the noble metal may be exposed at the surface to contact a gas or liquid, but may also be in direct physical contact with the support body and dispersed within a ceria coating over the surface of the support body. It is believed that small clusters or single atoms of noble metal are generally isolated, one from the other, within and/or on top of the ceria coating, which is substantially continuous over much or all of the surfaces of the support body. Thus, the catalysts herein are catalyst bodies, each of which has noble metal sites that are isolated from other noble metal sites on the same catalyst body. Each particle of the catalyst system has a structurally strong framework with a coating of ceria to provide enhanced hydrothermal stability and catalytic activity, and a noble metal highly dispersed by the ceria for catalytic activity.

In general any structurally strong material can be used as support, provided the support has sufficient surface area. Thus, other materials that can be used as support materials, optionally with other materials mentioned above, include magnesia, yttria, silica, and calcium oxide. A structurally strong support body can also be coated with a support material having high surface area prior to adding catalytic materials. Thus, for example, a support body comprising zirconia, titania, silica, silicon carbide, calcium oxide, and the like, alone or in any combination, can be coated with a porous, high surface-area coating of alumina, or another metal oxide or mixture thereof, to form a support body capable of being loaded with catalytic material for purposes herein. In such cases, a support pellet having nominal dimensions of 3-5 mm can have a structurally strong core body with a coating of porous alumina having a thickness up to about 0.1 mm. Such a coating can be applied by dispersing core bodies, as described above, into an aluminum oxide precursor solution, for example a solution of aluminum isopropoxide or aluminum chloride hydroxide, and heating the mixture mildly. The coated particles can be filtered, dried, and heated to a temperature of about 500 °C to about 1,000 °C to finish the coating. The particles made by such a process can then be subjected to processes described herein to apply ceria and noble metal catalyst.

The noble metal is highly dispersed on the ceria. Thus, it is believed that the catalyst system has gaps between particles of noble metal on or within the ceria coating that make portions of the ceria accessible to gas and/or liquid. Particles of the noble metal may be in direct physical contact with the surface of the support body, or may be separated from the surface of the support body by the coating of ceria. In one catalyst system, some particles of noble metal may contact the surface of the support body while other particles of noble metal are separated from the surface of the support body.

The noble metal dispersion may be substantially uniform or non-uniform. Thus, the noble metal may have a surface concentration that is substantially constant on the ceria, or in some cases the noble metal may have a surface concentration on the ceria that varies over short or long distances. Thus, in some cases, there may be areas of the ceria and/or the catalyst system particle where no noble metals can be detected. The catalyst preparation process may result in a monolayer of ceria deposited on surfaces of the support body that are accessible to gas or liquid, along with noble metal atoms co-deposited with the ceria in contact with the support body surface and accessible to gas or liquid to catalyze reactions.

The support is a body, for example a pellet or other shape, that is porous and thus has high surface area. The pellets can be shaped like cylinders, for example by cutting pellets from a cylindrical extruded mass, or like deformed cylinders if the pellet cutting is imprecise. The pellets can also have non-uniform shape. For example, pellets can be formed by sizing a large metal oxide mass into smaller bodies, for example by crushing or grinding. The pellets can also be shaped according to any suitable shape, such as spheres, rings, quadrilobes, monoliths, foams, fibers, daisies, and foils. Shaped pellets can be made by molding and/or sculpting. The support body has surface area of at least about 20 m²/g, such as between about 20 m²/g and about 400 m²/g, for example between about 200 m²/g and about 350 m²/g. Higher surface area usually leads to reduced pore size and pore volume of the porous body, and lower surface area generally reduces catalyst activity by reducing contact area between catalyst and process gas. The support body has pore volume of at least about 0.3 mL/g, for example between about 0.3 mL/g and about 1.5 mL/g. The catalyst system has surface area of at least about 20 m²/g, such as between about 20 m²/g and about 250 m²/g, for example between about 50 m²/g and about 150 m²/g. Surface area is measured using any reasonable BET method known in the art.

In general, the catalyst system will have at least 100 μg/g of the noble metal based on the total weight of the catalyst system, such as about 100 μg/g to about 100,000 μg/g, or about 500 μg/g to about 100,000 μg/g, or about 1,000 μg/g to about 50,000 μg/g, for example about 3,000 μg/g to about 5,000 μg/g. Also, in general, the catalyst system will have at least 0.01 g/g ceria, such as about 0.01 g/g to about 0.8 g/g, or about 0.1 g/g to about 0.7 g/g, for example about 0.2-0.4 g/g. Thus, an atomic ratio of cerium to noble metal is at least about 4 and may be as high as 450,000.

The particles of the catalyst system may be pellets that have generic shape, for example particles of dimension from about 1 mm to about 10 mm with some roundness and angularity in no particular range. In other cases, the particles may be shaped to maximize inter and intra particle mass and thermal transfer, maximize catalyst density within a reactor, minimize flow channeling in a reactor, and/or to obtain a desired pressure drop within the reactor. Shapes that can be used include bead shape, cylinders, trilobes, and quadrilobes. The catalyst system generally has a crush strength of at least about 5 N/mm, such as between about 5 N/mm and about 30 N/mm, for example about 15 N/mm. Shapes such as monolith or foam can be used in applications where low pressure drop is desired. Table 1, below, presents data regarding void fraction, pressure drop, crush strength, surface area, and mass transfer properties of catalyst pellets shaped in certain ways and deployed as a fixed catalyst bed in a reactor. As can be seen in the data of Table 1, these various properties have advantages and disadvantages that can be utilized and/or managed. For example, high surface area and high void fraction pellets usually result in good mass transfer, but can exhibit reduced crush strength. Table 1 shows values relative to a reference of spherical pellets (i.e. solid packed spheres) of similar dimension. Pressure drop of a gas flowing through packed spherical pellets can be approximated using the Ergun equation, which relates superficial gas flow velocity, viscosity, density, pellet size, and bed void fraction to the pressure drop exhibited by the gas flow.

TABLE 1
Pellet Properties

| | | | | External | | |
|---|---|---|---|---|---|---|
| | | | Crush | Surface | | |
| | | | Strength | Area / | | |
| | Bed Void | ΔP vs | vs | Volume vs | Relative | |
| Pellet | Fraction | spherical | spherical | spherical | Mass | |
| Shape | (ε) | pellets | pellets | pellets | Transfer | Comments |
| Solid | 0.40 | 1.00 | 1.00 | 1.00 | Low/medium | Reference; |
| Spheres | | | | | | compact |
| | | | | | | particle |
| Solid | 0.38-0.42 | 1.30-1.60 | 0.90 | 1.25 | Medium | Moderate ΔP |
| Cylinders | | | | | | and mass |
| | | | | | | transfer |
| Trilobes | 0.45-0.50 | 1.04-1.44 | 0.68 | 1.88-2.00 | High | Improved |
| | | | | | | external area |
| | | | | | | and diffusion |
| | | | | | | path |
| Quadrilobes | 0.48-0.53 | 0.91-1.28 | 0.59 | 2.00-2.25 | High/very | Excellent |
| | | | | | high | mass |
| | | | | | | transfer but |
| | | | | | | mechanically |
| | | | | | | weak |
| Daisy (5+ | 0.50-0.55 | 0.78-1.12 | 0.50 | 2.25-2.75 | Very high | High surface |
| lobes) | | | | | | area and |
| | | | | | | short |
| | | | | | | diffusion |
| | | | | | | path, but |
| | | | | | | mechanically |
| | | | | | | weak |
| Cylinder | 0.45-0.55 | 0.98-1.20 | 0.68-0.86 | 2.12-2.50 | High | Holes |
| with hole | | | | | | increase |
| | | | | | | surface area |
| | | | | | | and flow; |
| | | | | | | cylinder wall |
| | | | | | | thickness |
| | | | | | | affects |
| | | | | | | mechanical |
| | | | | | | strength |
| Honeycomb | 0.70-0.80 | 0.10-0.25 | 0.05 | 1.5-2.0 | Very high | Extremely |
| monolith | | | | | | low ΔP, high |
| | | | | | | channel flow |
| | | | | | | but thin walls |
| | | | | | | reduce crush |
| | | | | | | strength |
| | | | | | | sharply |
| Foil/metal | 0.90-0.95 | 0.01-0.05 | Varies | 3-5 | Extremely | Near-zero |
| gauze | | | | | high | ΔP, |
| | | | | | | extremely |
| | | | | | | high surface |
| | | | | | | area, but |
| | | | | | | mechanically |
| | | | | | | fragile |

Such catalyst structures can be subjected to the catalyst preparation processes described herein to produce catalyst pellets having ruthenium-ceria catalytic coating with a variety of surface area, mass and thermal transfer properties, mechanical strength, and bulk flow properties to suit various process needs.

The catalyst system can be made using many methods. For small support bodies having, for example, a dimension of about 3 mm or less and high surface area and/or pore volume, incipient wetness impregnation can be used to fully load the support bodies with catalyst throughout on exposed internal and external surfaces of the support bodies. The porous support body, which can be a pellet shape or any other suitable shape as described above, is immersed in a solution containing a noble metal reagent and a cerium salt. The volume of the solution is approximately equal to the total pore volume of the immersed support bodies so all the free liquid of the solution is absorbed by the support bodies without leaving appreciable free liquid outside the support bodies. The noble metal reagent may be a chloride reagent, or other soluble metal compound, and the cerium salt may be cerium nitrate or other soluble cerium salt. Mixtures of soluble noble metal compounds, and mixtures of soluble cerium salts can be used. The solvent is any solvent that can dissolve the noble metal reagent and the cerium salt. The solvent can be water or a mixture of water with a co-solvent such as alcohol.

The noble metal and the ceria may be applied to the support body concurrently in a single exposure process. The support body can be exposed to an aqueous solution containing ions of the noble metal and ions of cerium, with appropriately soluble counterions such as chloride and nitrate. Use of such preparation methods provides a useful catalyst structure that coats internal and external surfaces of the support body that are exposed to fluids. The noble metal and cerium ions associate to the support body surface concurrently from the aqueous solution. The cerium ions form a coating of ceria (cerium oxide) on exposed external and internal surfaces of the support body, and the noble metal forms noble metal sites on the support body that are on the ceria coating or associated to the support body surfaces with the ceria coating. Thus, the ceria coating may be between the noble metal sites and the support body surface, or the noble metal sites are in direct physical contact with the support body surfaces and are also exposed for access to fluids within and around the support body. In one single catalyst body, some noble metal sites may be separated from the support body surface by the ceria coating while other noble metal sites are in direct physical contact with the support body surface.

For support bodies having high surface area and/or pore volume, with nominal dimension of about 3 mm or more, methods of evaporative impregnation and/or dip-soak impregnation can be used to load the support bodies. For evaporative impregnation, the support is immersed into a solution of the above precursors having volume greater than the total pore volume of the immersed support bodies. Thus, an excess volume of the solution is used. The mixture of solution and support bodies is subjected to a slow evaporation process until the solids are dry. The mixture may be rotated during evaporation. For dip-soak impregnation, the support bodies are immersed in an excess solution for an extended duration to allow mass transport properties to drive catalyst species into the interior pores of the support bodies. Such treatments can be combined, and can also be combined with an incipient impregnation treatment as well. In many cases, the support bodies are fully impregnated with catalyst species such that the resulting catalyst system body is substantially homogeneous in composition. In other cases, especially where larger or less porous support bodies are used, the resulting catalyst system body may have a composition gradient, for example a declining concentration of catalyst species toward the center of a catalyst system body.

For support bodies with low surface area and/or low pore volume, and for structured supports that may have substantially divergent dimensions in different directions, a washcoating process can be used, optionally with any of the other methods described above. In a washcoating process, a thin porous layer of catalyst and/or support material is deposited onto a catalyst body, which may be a structured substrate such as a ceramic or metallic monolith. A slurry containing a dispersed suspension of metal oxides to be used as catalyst supports can be dip-coated or spray-coated onto a substrate. The slurry would typically contain particles of oxide with dimension of 1-10 μm, dispersed in a water solution optionally containing catalyst species as described above. The slurry may also contain binders such as silica sol and/or alumina sol to improve adhesion along with viscosity modifiers to provide good coating performance. After coating, the coated body is dried and excess material is removed by blowing or draining. The washcoating process, along with any of the other preparation processes described above, can be repeated to achieve any desired result.

The porous support bodies described above can have a high surface area due to porosity. In one example, an alumina extrudate having BET surface area of 200 m²/g or more and pore volume of 0.7 mL/g or more is used. BET surface area can be measured using ASTM method D3663. Pore volume can be measured using ASTM method D4222. Where alumina is used, the alumina may be of the gamma structure for maximum structural strength with high surface area, but other structures, such as alpha and beta alumina, can also be used, and combinations and mixtures of such structures can be used.

In some cases the catalyst system can be made by mixing a powder of alumina or boehmite, or pseudoboehmite, or any mixture thereof, with a solution of a cerium salt to form small granules. The granules can be shaped using methods such as extrusion or other shaping methods. The granules, or shaped bodies, can be dried, calcined, and then impregnated with a solution containing a noble metal, followed again by drying and calcination. In another alternate method, the powder of alumina, boehmite, or pseudoboehmite, or any mixture thereof, can be mixed with a solution of a cerium salt and a noble metal salt to form the small granules.

In an incipient impregnation process, the amount of the solution used may be substantially equal to the pore volume of the porous support body. A desired amount of the cerium and noble metal salts are added to the solution, for example based on a desired ratio of ceria mass and noble metal mass to mass of the porous support body. In an evaporative or dip-soak impregnation process, the amount of the solution used may be more than the pore volume of the porous support body. In such cases, the impregnated porous support body can be separated from excess solution by evaporation or filtering.

Concentration of noble metal and cerium compounds in the solution used for impregnation can be any reasonable concentration. Exposure of the support body to the solution can be selected to provide a target loading of ceria and noble metal based on the concentration of each in the solution. Noble metals that can be used include platinum, palladium, ruthenium, rhodium, and iridium. Mixtures of noble metals can be used by including more than one noble metal in the solution. Immersion of the porous support body in the solution is maintained for a permeation period to allow the solution to permeate, at least partially, the porous support body. Depending on the size of the porous support body, the permeation period can be from about 1 hour to 5 hours. A longer permeation period generally results in more complete permeation of the ceria coating and the noble metal throughout the gas-accessible surfaces of the porous support body. During the permeation period, the solution permeates through the porous support body, flowing into pores and through internal passage of the porous support body to deposit cerium and the noble metal on surfaces at the exterior of the porous support body and on surfaces within pores and internal passages of the porous support body. When a sufficiently long permeation period is used, the porous support body can be observed as completely and uniformly permeated by the solution and/or the ceria and noble metal.

A catalyst system of a support body fully loaded with catalyst species described herein is dried, typically at a moderate temperature selected to remove water and other liquids. For example, the porous support body can be dried at 100-120 °C, for example 110 °C, for a drying period that may be 6-12 hours, or longer, to remove most of the water, and other solvents, from the porous support body. In some cases, water may be completely removed from the porous support body in the drying process. The dried porous support body is then thermally treated to finish the catalyst system. The thermal treatment typically involves exposing the catalyst system to a temperature of about 500-900 °C for a duration of about 1-24 hours in an atmosphere of air or in an inert atmosphere. The finished catalyst system is typically subjected to a reducing treatment before production use, for example using hydrogen gas at an elevated temperature.

In one example, alumina extrudate particles (3 mm diameter, 5 mm long cylinder) are immersed in an aqueous solution of ruthenium chloride (RuCl₃) and cerium nitrate (Ce(NO₃)₃). The alumina extrudate particles have a piece crush strength of about 16.5 N/mm. In this example, concentration of ruthenium chloride in the aqueous solution is 0.097 mol/L and concentration of the cerium nitrate is 3.72 mol/L and the particles are immersed in the solution for an immersion time of 5 hours. After immersion, the particles are dried at 120 °C under air, nitrogen, or other non-reactive atmosphere for 12 hours. The dried particles are then thermally treated at 900 °C in air for 3 hours. The finished catalyst system, in this case, can be subjected to a reducing treatment by exposing the finished catalyst system to hydrogen gas at a temperature of 572 °F for at least 6 hours. The same procedure can be used to make a catalyst system that has platinum as the metal catalyst. Chloroplatinic acid (H₂PtCl₆) is used as the noble metal reagent. Other versions of the catalyst system can be made using different noble metals by using compounds of the noble metal in the procedure above. Mixtures of two or more noble metals can also be used by including reagents of two or more such metals in the solution above.

In general, the aqueous solution used for immersion treatment of support bodies can have a concentration of ruthenium, as the noble metal, that is at least about 0.05 mol/L, and the molar concentration of cerium will be at least about 4 times the molar concentration of ruthenium. The concentration of both ruthenium and cerium may be up to the solubility limit of the two salts in the solution. Thus, the immersion solution typically has at least about 0.05 mol/L of the noble metal and about 0.2 mol/L of cerium nitrate, and may have up to about 1.5 mol/L of the noble metal, for example ruthenium as ruthenium chloride, and up to about 6 mol/L cerium nitrate.

The catalyst systems described above can be used advantageously to manufacture syngas having a useful ratio of hydrogen to carbon monoxide in a single conversion pass. The catalyst system is staged in a reaction vessel to form a catalyst bed and a process gas is flowed through the catalyst system to perform the reaction. The process gas generally contains methane and carbon dioxide, optionally along with another source of hydrogen, oxygen, or both, and the reaction converts methane and carbon dioxide into hydrogen and carbon monoxide. For example, where the process gas contains no carbon dioxide, an oxygen source such as water is included. Likewise, where the process gas contains no methane, a hydrogen source such as hydrogen gas is included. Water and hydrogen can also be included, individually or together, in any process gas described herein.

Reaction conditions influence conversion of methane and/or carbon dioxide and the composition of the effluent. Under appropriate conditions, composition of the effluent can be optimized to provide a suitable ratio of hydrogen to carbon monoxide such that the effluent can be directly used in a Fischer-Tropsch process to manufacture organic chemicals. In most cases, initial methane conversion is at least about 80%, for example as high as 95%, and methane conversion is typically above about 90% for at least 120 hours of continuous reaction.

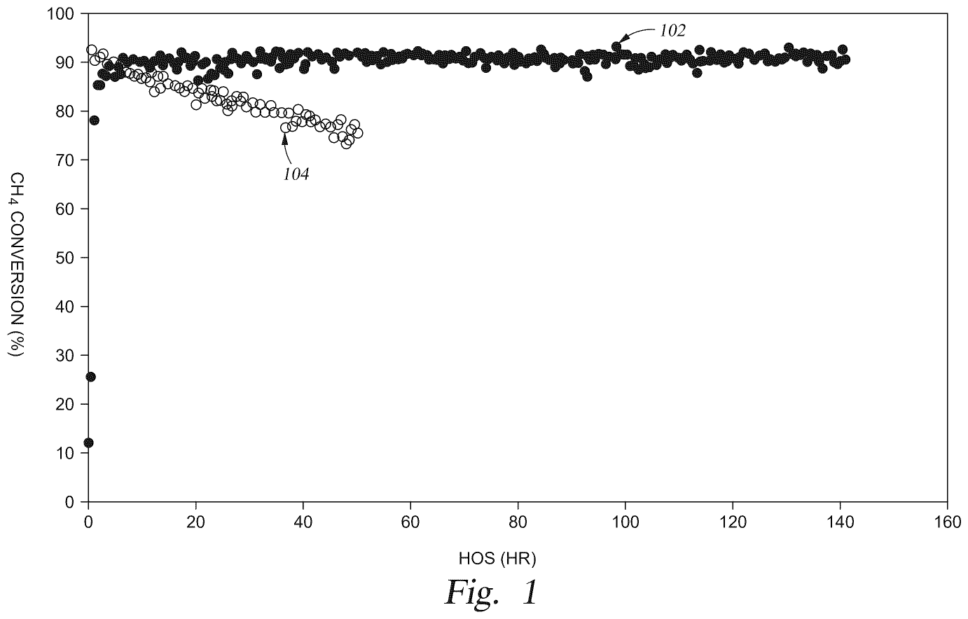

FIG. 1 is a graph showing conversion of methane for two different catalyst systems as a function of continuous processing time. Catalyst A is the ruthenium catalyst system described above and catalyst B is a platinum catalyst system made in a similar way. In the graph of FIG. 1, conversion of methane using catalyst A is shown at 102, and conversion of methane using catalyst B is shown at 104. Catalyst A has a BET surface area of 77.4 m²/g. Catalyst B has a BET surface area of 91.5 m²/g. These reactions, reaction group 1, were performed at a temperature of 1,640 °F and gas hourly space velocity (“GHSV”) of 30,000 hr⁻¹. To deploy the catalyst system in a reaction vessel, the catalyst system was crushed and screened to 20 to 40 mesh and diluted with silicon carbide. The resulting material was disposed into the isothermal zone of a clamshell electrical heated reactor. For all the examples herein, a process gas comprising 43 mol % methane, 14 mol % carbon dioxide, and 43 mol % steam was charged to the reactor containing the respective catalyst systems. Reactor outlet pressure was maintained at 50 psig. The product gas is analyzed using micro-GC after removing water to ascertain conversion of component gases.

As can be seen in FIG. 1, conversion of methane using catalyst B, at 104, was observed to decline substantially linearly over a continuous processing time while conversion using catalyst A, at 102, was stable. Over the period of the data of FIG. 1, conversion using catalyst A remained around 92% after an induction period of about 5 hours. Conversion using catalyst B was observed just above 90% initially, declining to about 75% by about 50 hours of continuous processing. From this data of FIG. 1, it can be concluded that catalyst A, representing the catalysts described herein, exhibits very stable conversion of methane over at least 140 hours of continuous processing while conversion deteriorates over a similar period using catalyst B.

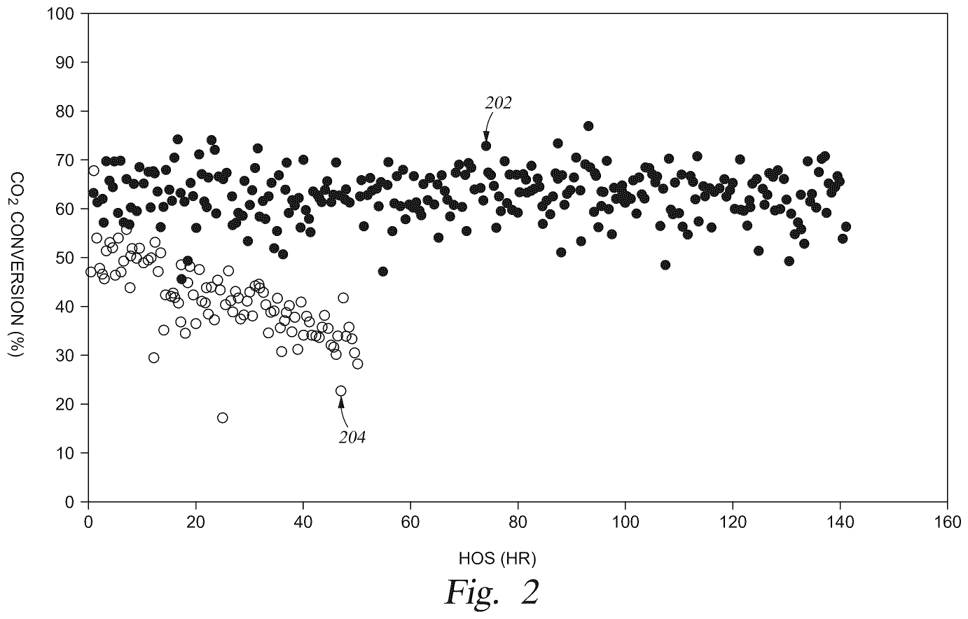

FIG. 2 is a graph showing conversion of carbon dioxide for the reactions described above. Conversion using catalyst A is shown at 202 and conversion using catalyst B is shown at 204. As seen in the graph of FIG. 2, conversion of carbon dioxide using catalyst A remained around 64%. Conversion using catalyst B was initially around 51% and declined approximately linearly to around 30% over about 50 hours of continuous processing. From the data of FIG. 2, it can be concluded that, like methane conversion, carbon dioxide conversion using catalyst A is substantially stable while conversion using catalyst B degrades over time.

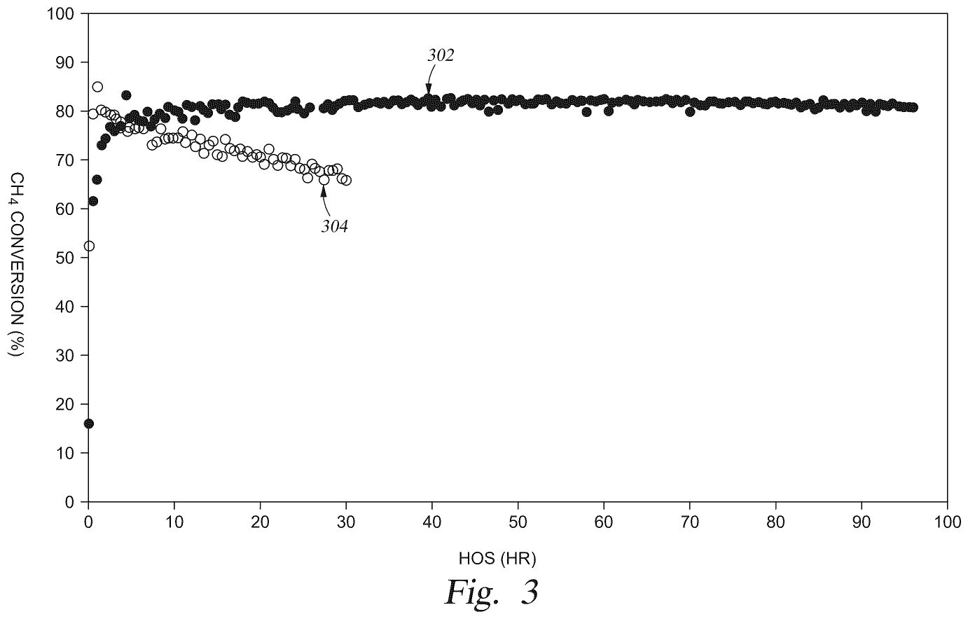

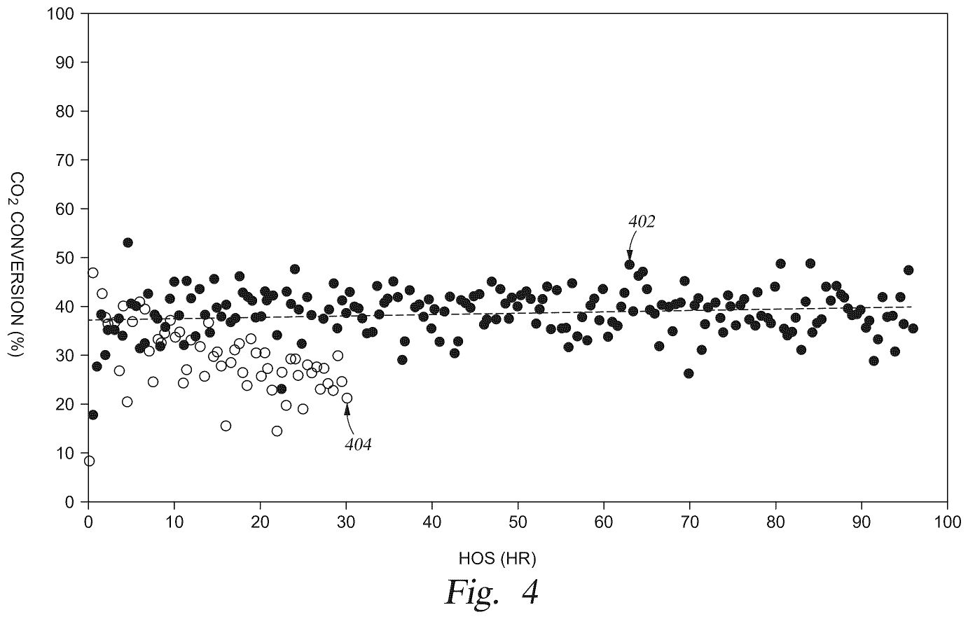

FIGS. 3 and 4 are graphs showing conversion of methane and carbon dioxide, like the graphs of FIGS. 1 and 2, but under different reaction conditions. The reactions of FIGS. 3 and 4, reaction group 2 for catalysts A and B, are at GHSV of 64,361 hr⁻¹ so contact time between process gas and catalyst in reaction group 2 is just under 50% of contact time for reaction group 1. In FIG. 3, conversion for catalyst A is shown at 302 and for catalyst B at 304. In FIG. 4, conversion for catalyst A is shown at 402 and for catalyst B at 404. For these reactions, from the data of FIGS. 3 and 4, it can be concluded that the conversions of methane and carbon dioxide decline linearly over time using catalyst B, but using catalyst A the conversions rise over a short initial period and stabilize for the remainder of the test period. Following the testing, catalyst B was observed to have a BET surface area of 51.2 m²/g, exhibiting significant reduction in surface area during the testing.

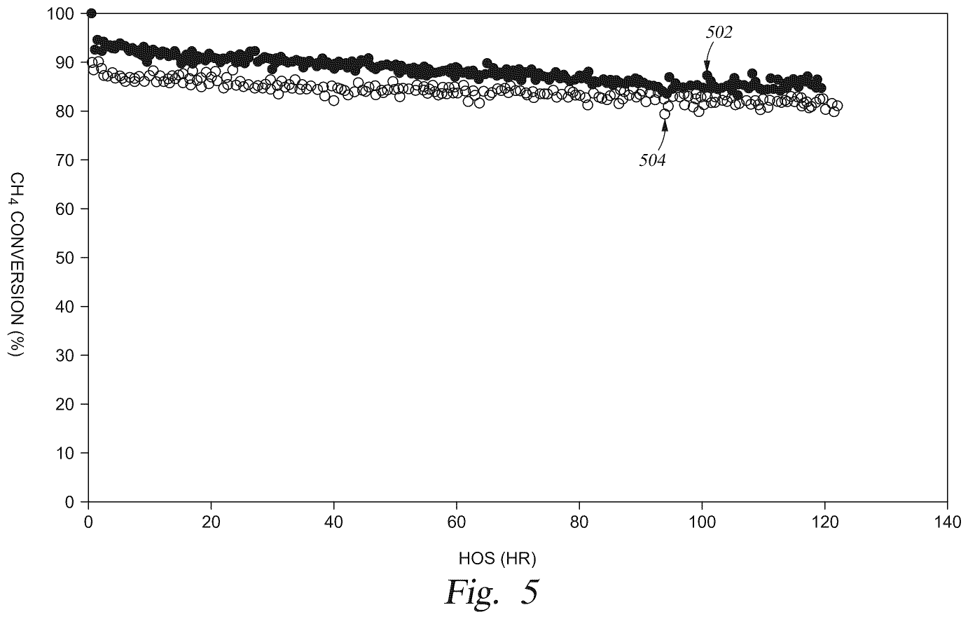

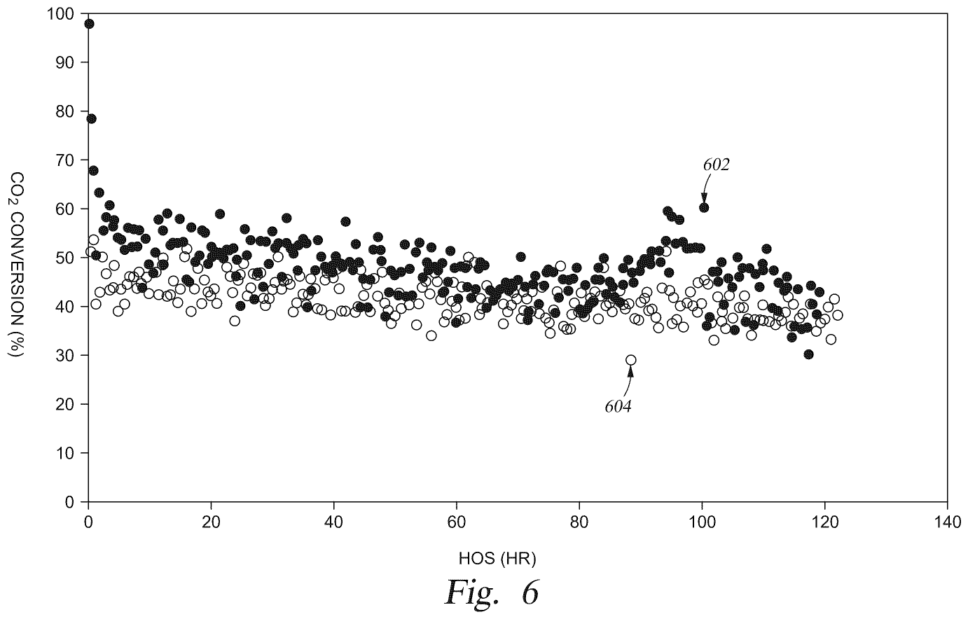

FIGS. 5 and 6 are graphs that show performance of catalyst B in comparison with catalyst C, a platinum catalyst system made from a support body that is a physical mixture of 80% CeO₂ and 20% Al₂O₃ using methods otherwise similar to those described herein, but with no ceria coating. Catalyst C had BET surface area of 135.9 m²/g and crush strength of only 4.3 N/mm. Catalyst C shows the performance of a support body that is mostly ceria but with a small amount of alumina as binder for strength. FIG. 5 shows methane conversion over approximately 120 hours of continuous processing for catalyst B at 502, and for catalyst C at 504. FIG. 6 shows carbon dioxide conversion for the two catalyst systems. Conversion for catalyst B is shown in FIG. 6 at 602, and conversion for catalyst C is shown at 604. These reactions are performed at GHSV 10,000 hr⁻¹. The data of FIGS. 5 and 6 show that conversion of both gases declines over time using either catalyst system, and while methane conversion is initially similar to the stable conversions shown for ruthenium catalysts in FIGS. 1 and 3, the conversion declines over the 120 hours processing time to about 85%. Catalyst C has initial methane conversion around 90%, which declines to around 80%. Carbon dioxide conversion is likewise lower than that exhibited by catalyst A, initially 40-60% and declining to 30-45%.

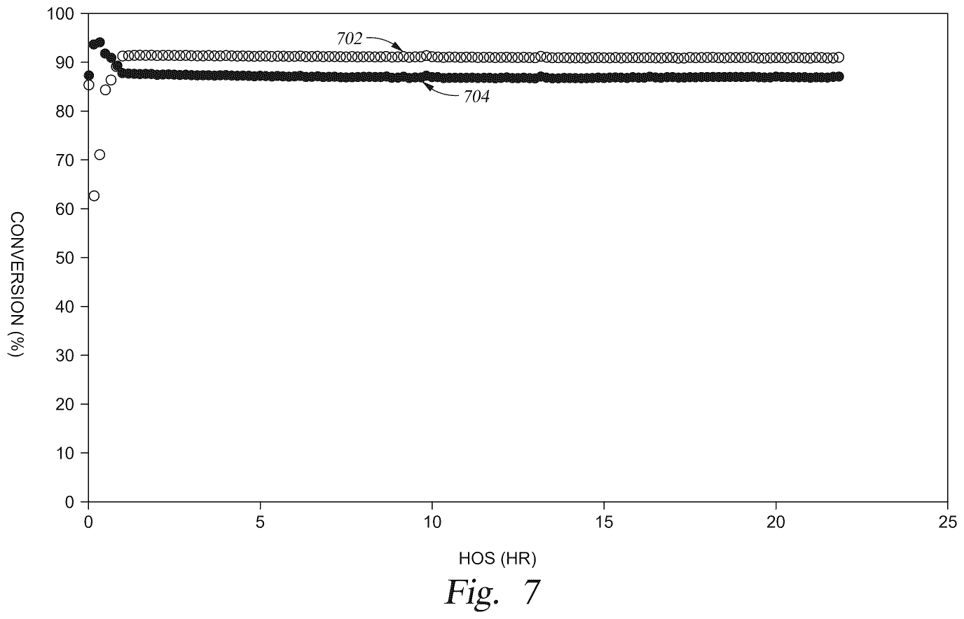

In another example, zirconium oxide pellets, shaped as cylinders having diameter of 2.64 mm and length of 3.23 mm (available from DKK Americas Materials, Inc., of Livonia, Michigan) are used as support bodies. The particles have a piece crush strength of about 9 N/mm and a surface area of 81.3 m²/g. The support bodies are impregnated with an aqueous solution containing 0.13 mol/L ruthenium chloride (RuCl₃) and 2.58 mol/L cerium nitrate (Ce(NO₃)₃) for 5 hours. After immersion, the particles are dried in air at 120 °C for 12 hours. The dried particles are then thermally treated in air at 900 °C for 3 hours. The resulting particles were crushed and screened to 20 to 40 mesh and diluted with silicon carbide to form a catalyst system mixture. The catalyst system mixture was disposed into the isothermal zone of a clamshell electrically heated reactor and heated to 900 °C under 100 sccm of hydrogen gas. Upon reaching the target temperature, operating pressure of 50 psig was established, and under continuous gas flow, the hydrogen gas was replaced with a process gas flow of 50 mol % methane and 50 mol % carbon dioxide at GHSV of 64,361 hr⁻¹. FIG. 7 is a graph showing conversion of methane and carbon dioxide for this example. Methane conversion is shown at 704 and carbon dioxide conversion is shown at 702. The graph of FIG. 7 exhibits high, stable single-pass conversion of both species, methane at about 88% and carbon dioxide at about 91%, for at least 22 hours of continuous operation.

Thus, a ruthenium catalyst system made using a ceria-coated alumina support, or support made of other metal oxide, such as zirconia, or mixture of metal oxides, such as silica-alumina mixtures like zeolite, achieves high, apparently stable conversions of methane and carbon dioxide in a syngas manufacturing process and can withstand the flow conditions of a high gas flow process. In general, a noble metal deposited on a ceria-coated porous support having high surface area and structural strength can be used to react a process gas containing methane and/or carbon dioxide, optionally with steam and/or hydrogen gas present, to make hydrogen and carbon monoxide. The reaction is performed at a temperature of 700 to 1,000 °C and the temperature can be selected to optimize composition of the effluent syngas for chemicals manufacture. GHSV can be up to 70,000 hr⁻¹, and conversion of methane, carbon dioxide, or both at such conditions is stable, using the catalyst described herein, for at least 120 hours of continuous operation before regenerating the catalyst.

In general, the catalyst system can be disposed in a fixed bed, a fluidized bed, or a partially fluidized bed, for example between two mesh screens that immobilize the catalyst system particles for a fixed bed or allow the catalyst system particles to move for a fluidized bed or partially fluidized bed. A partially fluidized bed is a configuration that allows a small amount of movement for particles but generally does not allow free flow or circulation of particles within a space. As noted above, the catalyst system particles are sized to any appropriate size for the constraints used to structure the catalyst bed, by crushing, grinding, or other solids sizing methods.

The catalyst system can be prepared for production by exposing the catalyst system to a reducing environment, which may be hydrogen gas, or another reducing reagent, or a gas containing such reducing reagent. For example, the catalyst system particles can be exposed to a pure hydrogen gas or to a gas that contains any suitable amount of hydrogen. In the context of a syngas manufacturing process, hydrogen streams are often available for recycle, either from the syngas process itself or from a Fischer-Tropsch chemicals manufacturing process downstream. In such cases, recycled hydrogen gas can be used to reduce the catalyst system for production. The reducing process is carried out at moderate temperature of 200 to 500 °C, for example 300 °C, for a period that reaches a zero hydrogen conversion, or near zero hydrogen conversion, point. Such end point for the reducing process can be ascertained by monitoring effluent composition for hydrogen conversion in the catalyst system.

After reducing treatment is complete, a feed gas containing carbon and hydrogen as methane and/or carbon dioxide, and optionally hydrogen and/or steam, can be charged to a pressure vessel containing the catalyst system for production of syngas. The reaction is generally performed at a nominal pressure of 10-500 psig and temperature of 700 to 1,000 °C. The pressure vessel may be lined with a suitably temperature- and chemistry-resistant material to prevent any deleterious effects on catalyst particles, such as interaction with metal materials of the reactor. For example, the pressure vessel can have a ceramic lining, which may be polished smooth. Using suitable equipment, the reaction can be performed at higher pressures, for example at 100 or 150 psig, and up to 500 psig. Gas flow rate can be up to about 70,000 GHSV, as shown by the data herein, and can be any reasonable value below 70,000 GHSV. Processing a gas containing 43 mol % methane, 14 mol % carbon dioxide, and 43 mol % steam using the catalyst systems described herein can yield a syngas stream having 65 mol % hydrogen, 29 mol % carbon monoxide, 2 mol % methane, 4 mol % carbon dioxide, which can be advantageously used in a Fischer-Tropsch process to manufacture organic chemicals.

In general, the catalysts herein can be used in reforming of hydrocarbons and/or carbon dioxide to form syngas. These catalysts feature high single-pass conversion of both light hydrocarbons, such as methane, and carbon dioxide into syngas having a molar ratio of hydrogen gas to carbon monoxide of at least 1.5. Reaction conditions and feed mixture can be tailored to influence the molar ratio by favoring or disfavoring certain reactions and/or separating and recycling excess hydrogen gas.

A catalyst, or mixture of catalysts, described herein is loaded into a container to host the reactions. The container can be a tube, tank, drum, or any suitable container that can hold the catalyst particles described herein. A feed gas is flowed through the container holding the catalyst, and the reaction space is heated to supply energy to drive the endothermic reforming reactions. The catalyst can be loaded into the container in such a way that the gas flow results in no movement of the catalyst particles, to give a fixed bed, slight movement of the catalyst particles, to give a partially fluidized bed, or comprehensive and global movement of catalyst particles, to give a fluidized bed. Fixed beds are generally preferred to maximize surface area of contact between catalyst and reactants, and therefore conversion of reactants to products, but other flow paradigms can be used.

The container can have internal structures, such as baffles, vanes, trays, mesh plates, and the like, to influence flow of gas through the catalyst. Generally, it is desired to make gas flow around the catalyst particles as uniform as possible. A catalyst bed support can be used to locate the catalyst bed at desired elevation above the container floor or bottom, and a catalyst bed lid can be disposed above the catalyst bed to constrain or prevent movement of catalyst particles in the container.

The feed gas contains hydrocarbons, for example light hydrocarbons such as methane, ethane, and propane, and may also contain carbon dioxide, hydrogen gas, and water as steam. The catalysts herein provide high single-pass conversions of CH₄ and carbon dioxide in gases having substantial partial pressure of both molecules. The feed gas is flowed through the catalyst within the container at a rate that provides suitable residence time for contacting carbon-containing molecules with reactive sites on the catalyst particles. In many cases, the reaction space and/or catalyst bed is maintained at a temperature between about 400 °C and about 1,000 °C, such as between about 500 °C and about 900 °C, for example between about 700 °C and about 900 °C. Pressure in the reactor is maintained between about 10 psig and about 500 psig. Depending on amounts of methane, carbon dioxide, and hydrogen gas in the feed gas, water may be added, in the form of steam, as an additional reactant (i.e. source of hydrogen and/or oxygen) and/or to minimize sooting and coke formation.

Although the catalysts herein are stable under normal operating conditions, as described above, long term use can still result in some decline in activity for some catalysts. In such cases, the catalyst can be subjected to a regeneration process to recover most or all activity by treating the catalyst using hydrogen stripping, steam stripping, air oxidation, combined hydrogen and steam stripping, or combined steam and air stripping, at a temperature of about 400 °C to about 900 °C for a treatment duration that may be from about 1 to about 24 hours.

While the foregoing is directed to embodiments of one or more inventions, other embodiments of such inventions not specifically described in the present disclosure may be devised without departing from the basic scope thereof, which is determined by the claims that follow.

1. A syngas manufacturing catalyst system, comprising:
a support comprising a solid porous support body at least partially permeated by a ceria coating; and
ruthenium permeating the porous ceria modified support body.

2. The catalyst system of claim 1, wherein the support body is a metal oxide pellet having a surface area of at least about 20 m²/g and a crush strength of at least about 5 N/mm.

3. The catalyst system of claim 1, wherein the ceria is present in an amount that is from about 0.01 g/g to about 0.8 g/g and the ruthenium is present in an amount that is from about 500 μg/g to about 100,000 μg/g.

4. The catalyst system of claim 1, wherein an atomic ratio of cerium to ruthenium is at least about 4.

5. The catalyst system of claim 1, wherein the support comprises alumina or zirconia or both.

6. The catalyst system of claim 1, wherein the support body has ruthenium sites isolated from other ruthenium sites on the support body.

7. The catalyst system of claim 1, wherein the solid porous support body is permeated by a coating containing ceria and ruthenium.

8. The catalyst system of claim 1, wherein the catalyst system has a surface area of about 50 m²/g to about 150 m²/g and a crush strength of at least about 5 N/mm.

9. A method of making a catalyst system, comprising:
immersing a porous support body in a solution comprising a ruthenium salt and a cerium salt for a permeation period;
drying the porous support body; and
thermally treating the dried porous body.

10. The method of claim 9, wherein the ruthenium salt is ruthenium chloride and the cerium salt is cerium nitrate.

11. The method of claim 10, wherein a molar concentration of cerium nitrate in the solution is at least about 4 times a molar concentration of ruthenium chloride in the solution.

12. The method of claim 10, wherein the support body is a metal oxide pellet having a surface area of at least about 20 m²/g and a crush strength of at least about 5 N/mm.

13. The method of claim 12, wherein the metal oxide is alumina, zirconia, or mixture thereof.

14. The method of claim 9, wherein the solution comprising the ruthenium salt and the cerium salt is a solution of ruthenium chloride and cerium nitrate having at least about 0.05 mol/L ruthenium chloride and at least about 0.2 mol/L cerium nitrate.

15. A method of making syngas, comprising:
exposing a gas comprising methane, carbon dioxide, or both, and a hydrogen source, and oxygen source, or both, to a catalyst system at a reforming temperature, wherein the catalyst system comprises:
a metal oxide support comprising a solid porous support body at least partially permeated by a ceria coating; and
ruthenium permeating the porous ceria-modified support body.

16. The method of claim 15, wherein the support body is a metal oxide pellet having a surface area of at least about 20 m²/g and a crush strength of at least about 5 N/mm.

17. The method of claim 15, wherein the ceria coating and the ruthenium are applied to the support body concurrently in a single exposure process.

18. The method of claim 15, wherein the reforming temperature is from about 400 °C to about 1,000 °C, and exposing the gas to the catalyst system comprises flowing the gas at a gas hourly space velocity of up to 70,000 hr⁻¹.

19. The method of claim 15, wherein the catalyst is disposed in a fixed bed within a vessel.

20. The method of claim 15, wherein at least about 90% of carbon atoms in methane are converted to carbon monoxide, at least about 60% of carbon atoms in carbon dioxide are converted to carbon monoxide, or both.
